(19) United States
(12) Patent Application Publication
(10) Pub. No.: US 2011/0259807 A1
(43) Pub. Date: Oct. 27, 2011

(54) FILTERING AND CONDENSING APPARATUS OF SUCTION TYPE

(75) Inventors: Hiroyasu Yamane, Tokyo (JP); Tadashi Kunitani, Tokyo (JP); Eiji Sakai, Tokyo (JP)

(73) Assignee: METAWATER Co., Ltd., Minato-ku, Tokyo (JP)

(21) Appl. No.: 12/442,396

(22) PCT Filed: Feb. 19, 2009
(86) PCT No.: PCT/JP2009/000702

§ 371 Date: May 9, 2011

(30) Foreign Application Priority Data
Sep. 25, 2008 (JP) 2008-246343

(51) Int. Cl. B01D 25/00

(52) U.S. Cl. 210/231

(57) ABSTRACT

An object of the present invention is to provide a filtering and condensing apparatus of the suction type which is capable of securing the filtering performance without deteriorating the filtering efficiency.

A filtering and condensing apparatus of a suction type comprises a sludge tank for containing sludge to be filtered and condensed, and a filtering plate disposed to be in the sludge tank and extending in the vertical direction of the sludge tank. The filtering plate includes vertical extending convex and concave portions on its surface, and a filtering cloth in a bag form to house the supporting plate, whereby a filtering chamber is formed between the filtering cloth and the filtering plate and a main flow passage for the filtrate which vertically extends is formed between the inner surface of the filtering cloth and the concave portion of the supporting plate. The apparatus further includes a means for sucking the filtering cloth through the filtering chamber, a means for expanding the filtering cloth through the filtering chamber by feeding an air toward the filtering cloth via the filtering chamber, and a filtrate discharge tube one end of which is communicated with the filtering chamber. The lateral length of the filtering cloth is set to be longer than the lateral length of the supporting plate over its entire vertical direction, whereby, in a case where the sludge in the sludge tank is filtered and condensed under the predetermined negative pressure by the sucking means, a temporary sub-flow passage for the filtrate which is communicated with the filtering chamber and extends in the vertical direction of the filtering chamber is formed.

### TECHNICAL FIELD

The present invention relates to a filtering and condensing apparatus of a suction type, and, in particular, relates to such an apparatus which is capable of preventing a slack of a lower portion of a filtering cloth, while at the same time of maintaining an integrity of such a filtering cloth.

### BACKGROUND OF THE INVENTION

Conventionally, a filtering and condensing apparatus of a suction type has been adopted in order to condense agglomerate sludge generated at a water purification plant, for instance. One example of such an apparatus is disclosed by Japanese Patent Publication HEI03-23203.

This filtering and condensing apparatus comprises a sludge tank for containing sludge which is to be filtered and condensed, and a plurality of filtering plates disposed to be adjacent to each other so as to be aligned with each other in the sludge tank, each of which extends in a vertical direction of the sludge tank. Each of the filtering plates includes a supporting plate and a filtering cloth in a bag form which is integrally sewed on the supporting plate and houses the supporting plate to form a filtering chamber therein. A filtrate discharge tube is communicated with the filtering chamber so as to discharge the filtrate therethrough. In addition, a suction portion for sucking the filtering cloth through the filtering chamber and an expansion portion for expanding the filtering cloth through the filtering chamber are provided, and coil springs for always applying a tension force to each of the filtering plates are provided around its periphery.

According to the above structure of the filtering and condensing apparatus, in case of filtering, a sludge in the sludge tank is sucked and thus filtered by the filtering clothes, so that the condensed sludge is deposited on the outer surfaces of the filtering clothes, while the filtrate which has passed through the filtering clothes and thus guided into the filtering chambers can be recovered outside of the sludge tank through the filtrate discharge tube.

In particular, as shown in FIG. 7, a supporting plate 302 includes concave and convex portions extending in the longitudinal direction at its surface, and a flow passage 306 is formed in a space between an inner surface of the filtering cloth 300 and the adjacent convex portions 304 of the corresponding supporting plate 302, whereby the filtrate which has passed through the filtering cloth 300 is discharged outside of the filtering and condensing apparatus through the flow passage 306 extending in the vertical direction of the filtering cloth 300. In this respect, it is important to secure the permeability of the filtrate through the flow passage, in view of securing the filtering performance.

On the other hand, in a case where the condensed sludge is recovered, the filtering cloth is expanded by feeding a compressed air to the inner surface of the filtering cloth via the filtering chamber, whereby the condensed sludge deposited on the outer surface of the filtering cloth is separated from the filtering cloth, and then, the condensed sludge deposited on the bottom of the sludge tank is discharged, so that the discharged sludge can be incinerated or reclaimed in the form of cakes by mechanically hydrating it. According to such filtering and condensing processes of the sludge, it is possible to alleviate an energy load needed for the mechanical hydrating process such as the pressuring, or the depressurizing, etc.

However, such a conventional filtering and condensing apparatus of suction type includes the following technical problem.

That is to say, the clogging of the filtrate flow passage formed between the filtering cloth and the supporting plate can be caused to deteriorate the filtering performance. More specifically, after the filtering is conducted for a long time, a small amount of small solid particles can be intruded into the flow passage via the filtering cloth, which constitutes a ground for the clogging of the flow passage formed in a narrow space between the filtering cloth and the supporting plate. Such a clogging of the flow passage can deteriorate the permeability of the filtrate, and thus worsen the filtering performance. In case of a large-sized apparatus for filtering and condensing the sludge which is used for treating agglomerated sludge generated at a water purification plant, for instance, such deterioration of the filtering performance can be caused in three to twelve months if it is continuously operated around the clock.

In order to recover the filtering performance, it is necessary to halt the operation of the apparatus on a regular basis and to clean the filtering plate and remove the small solid particles. This causes the operating rate of the apparatus to be decreased, thereby causing the filtering efficiency to be decreased.

### SUMMARY OF THE INVENTION

In view of the above technical problems, an object of the present invention is to provide a filtering and condensing apparatus of the suction type which is capable of securing the filtering performance without deteriorating the filtering efficiency.

In view of the above technical problems, according to an aspect of the invention, there is provided a filtering and condensing apparatus of a suction type comprises a sludge tank for containing sludge to be filtered and condensed, and a filtering plate disposed to be in the sludge tank and extending in the vertical direction of the sludge tank, said filtering plate includes vertical extending convex and concave portions on its surface, and a filtering cloth in a bag form to house said supporting plate, whereby a filtering chamber is formed between the filtering cloth and said filtering plate and a main flow passage for the filtrate which vertically extends is formed between the inner surface of the filtering cloth and the concave portion of said supporting plate, said apparatus further includes a means for sucking said filtering cloth through said filtering chamber, a means for expanding said filtering cloth through said filtering chamber by feeding an air toward the filtering cloth via the filtering chamber, and a filtrate discharge tube one end of which is communicated with said filtering chamber, characterized in that the lateral length of the filtering cloth is set to be longer than the lateral length of the supporting plate over its entire vertical direction, whereby, in a case where the sludge in said sludge tank is filtered and condensed under the predetermined negative pressure by said sucking means, a temporary sub-flow passage for the filtrate which is communicated with said filtering chamber and extends in the vertical direction of the filtering chamber is formed.

According to the above filtering and condensing apparatus of the suction type, by sucking and thus filtering the sludge contained in the sludge tank through the filtering clothes, water contained in the sludge passes through the filtering clothes and is guided into the filtering chambers and then flows through the main flow passages formed on the supporting plates to be discharged outside via the filtrate discharge tubes, and as a result, the sludge is filtered and thus condensed by the dehydrated sludge being deposited on the outer surfaces of the filtering clothes.

In this case, since the lateral length of the filtering cloth is set to be longer than the lateral length of the corresponding supporting plate over its entire vertical direction, the filtering cloth is pressed against the surface of the corresponding supporting plate due to the hydraulic pressure by the sludge and the predetermined negative pressure applied to the filtering cloth via the corresponding filtering chamber, and thus, most of the filtering cloth is adhered to the surface of the corresponding supporting plate, while the wrinkled portion which does not adhere thereto is also formed. A vertically extending space is formed between the inner surface of the wrinkled portion and the surface of the corresponding supporting plate, and said space is communicated with the corresponding filtering chamber defined by the inner surface of the filtering cloth and the corresponding supporting plate. Accordingly, the filtrate which has passed through the filtering cloth can vertically flows through the space, and thus, the space can function as a sub-flow passage with respect to the main flow passage of the filtrate formed on the corresponding supporting plate, whereby permeability of the filtrate can be improved.

In a case where the filtering cloth is expanded by the filtering cloth expanding means in order to separate the condensed sludge deposited on the surface of the filtering cloth, the entire inner surface of the filtering cloth is caused to be detached from the surface of the corresponding supporting plate, while at the same time the wrinkled portion which does not adhere to the surface of the corresponding supporting plate is caused to disappear. This causes the inner sub-flow passage to disappear, however, in a case where the expansion of the filtering cloth is halted and the filtering operation is carried out again, the wrinkled portion is formed again, whereby the inner sub-flow passage of the filtrate is formed again.

In this case, since the filtering cloth can be damaged due to the fact that the wrinkled portion is formed repeatedly, it is necessary to set the negative pressure caused by the sucking means to be a predetermined value so as to provide a filtering function for a long time without badly influencing on the filtering cloth. The predetermined value may be determined in accordance with the material, the size, and the thickness of the filtering cloth, or the amount of the sludge deposited on the surface of the filtering cloth.

As described above, the sub-flow passage of the filtrate is temporary in that it is newly formed every time the filtering operation is carried out and it disappears every time the filtering cloth is expanded. Accordingly, since it has a self-purification characteristics, there is no risk of the clogging by the foreign objects which can be caused by the main flow passage formed on the supporting plate, and thus, it can function as a sub-flow passage for the main flow passage. Therefore, the filtering efficiency can be maintained because the operation of the filtering and condensing apparatus of the suction type need not be halted in order to remove the clogging which occurs in the main flow passage, while at the same time the filtering performance can be secured by maintaining the permeability of the filtrate.

According to a preferred configuration, said filtering cloth is integrally sewed on said supporting plate, and is divided in the lateral direction of the supporting plate by a plurality of vertically extending seams to form said filtering chamber at every divided zone, the lateral length of the divided zone of the filtering cloth divided by the adjacent seams is set to be longer than the lateral length of the supporting plate corresponding to said divided zone over its entire vertical direction, whereby said temporary sub-flow passage is formed at every divided zone.

According to a preferred configuration, a negative pressure caused by said sucking means is set to be higher than the predetermined value in such a way that a wrinkled portion of the filtering cloth formed upon filtering does not deteriorate an integrity of the filtering cloth.

According to a preferred configuration, said predetermined value is higher than −0.09 Mpa in a case where the filtering cloth is made of nylon.

According to a preferred configuration, said filtrate discharge tube is a downwardly extending tube of a siphon type disposed to be in the form of a reverse U-shape.

According to a preferred configuration, said filtering plate includes a plurality of filtering plates aligned with each other in said sludge tank, each plane portion of which vertically extends.

According to a preferred configuration, the lateral length of the divided zone of the filtering cloth is determined in accordance with the amount of the protrusion of the filtering cloth toward the adjacent filtering plate upon the expansion of the filtering cloth and the distance between the adjacent filtering plates.

According to a preferred configuration, a means for always applying a tension force to each of the filtering plates are provided around its periphery, the means for applying a tension force from both sides of each of the filtering plates consists of an elastic member extending in its lateral direction, said supporting plate is made of a rigid material which causes substantially neither extension in its plane due to the immersion of the filtering cloth into the sludge, substantially nor contraction in its plane due to the expansion of the filtering cloth, and causes substantially no deformation so as to deteriorate a flatness of the supporting plate due to the immersion and the expansion of the filtering cloth.

According to a preferred configuration, said supporting plate is made of polyethylene.

According to a preferred configuration, said supporting plate is made of EVA.

In view of the above technical problems, according to an aspect of the invention, there is provided a filtering and condensing apparatus of a suction type comprises a filtering and condensing tank for containing a liquid to be filtered and condensed, and a filtering plate disposed to be in the filtering and condensing tank and extending in the vertical direction of the filtering and condensing tank, said filtering plate includes vertical extending concave and convex portions on its surface, and a filtering cloth in a bag form to house said supporting plate, whereby a filtering chamber is formed between the filtering cloth and said filtering plate and a main flow passage for the filtrate which vertically extends is formed between the inner surface of the filtering cloth and the concave portion of said supporting plate, said apparatus further includes a means for sucking said filtering cloth through said filtering chamber, a means for expanding said filtering cloth through said filtering chamber by feeding an air toward the filtering cloth via the filtering chamber, and a filtrate discharge tube one end of which is communicated with said filtering chamber, characterized in that the lateral length of the filtering cloth is set to be longer than the lateral length of the supporting plate over its entire vertical direction, whereby, in a case where the sludge in said sludge tank is filtered and condensed under the predetermined negative pressure by said sucking means, a temporary sub-flow passage for the filtrate which is communicated with said filtering chamber and extends in the vertical direction of the filtering chamber is formed.

### Effect of the Invention

According to the filtering and condensing apparatus of a suction type of the present invention, the sub-flow passage of the filtrate, which is formed on the inner surface of the filtering cloth in a case where the material to be treated contained in the liquid is filtered and condensed, is adapted to communicate with the filtering chamber similar to the main flow passage formed on the supporting plate and is temporary in that it is newly formed every time the filtering operation is carried out and that it disappears every time the filtering cloth is expanded, and thus, it has a self-purification characteristics so that there is no risk of the clogging by the foreign objects which can be caused by the main flow passage, whereby it can function as a sub-flow passage for the main flow passage, so that the filtering efficiency can be maintained, while at the same time the filtering performance can be secured.

### DETAILED DESCRIPTION OF EMBODIMENTS OF THE INVENTION

The first embodiment in which sludge generated at a sewage disposal plant or a water purification plant is to be filtered and condensed will be described in detail with reference to the drawings.

As shown in FIG. 1, a filtering and condensing apparatus 10 generally comprises a sludge tank 12 for containing sludge which is to be filtered and condensed, a plurality of filtering plates 14 disposed to be within the sludge tank 12, a suction portion 16 for sucking the sludge, and an expanding portion 20 for expanding a filtering cloth 18 provided on each of the filtering plates 14.

The sludge tank 12 is a container including a bottom with a rectangular cross section and includes a volume so as to house the plurality of the filtering plates 14 which are described below. One end of a sludge supply/discharge tube 24, which supplies the sludge to the sludge tank 12, is communicated with a sidewall 22 of the sludge tank 12, and a sludge supply/discharge pump 28 which can be reversibly operated is provided via a sludge supply/discharge valve 26 provided on an intermediate part of the sludge supply/discharge tube 24. This causes the sludge to be supplied to the sludge tank 12 by opening the sludge supply/discharge valve 26 and operating a sludge supply/discharge pump 28, while causes the non-condensed sludge to be discharged from the sludge tank 12 by reversibly operating the sludge supply/discharge pump 28. In addition, one end of a condensed sludge discharge tube 30, which discharges the condensed sludge deposited on the bottom of the sludge tank 12, is communicated with the bottom portion of the sludge tank 12 and a condensed sludge discharge valve 32 is provided on an intermediate part of the condensed sludge discharge tube 30. The condensed sludge deposited on the bottom of the sludge tank 12 is discharged outside due to the force of gravity via the condensed sludge discharge tube 30 by opening the condensed sludge discharge valve 32.

As shown in FIG. 2, the plurality of the filtering plates 14 (14A to 14 E) are aligned with each other in the sludge tank 12 in such a way that their plane portions 13 extend in the vertical direction and the adjacent filtering plates 14 are spaced apart from each other with a predetermined distance D. The smaller the distance D between the adjacent filtering plates 14 becomes, the higher the number of the filtering plates 14 which can be housed within the sludge tank 12 becomes, whereby the total filtering area can be increased accordingly. However, as described below, it is necessary to expand the filtering cloth 18 in order to separate the condensed sludge deposited on the filtering cloth 18 from the corresponding filtering plate 14. Since the filtering cloth 18 protrudes toward the adjacent filtering plate 14 due to the expansion of the filtering cloth 18, there is a risk that the filtering cloth 18 can contact the adjacent filtering plate 14, so that the filtering area cannot be effectively utilized. Such being the case, the distance between the adjacent filtering plates 14 may be determined, in view of the condition that the adjacent filtering plates 14 remain in non-contact, while the total filtering area is maximized.

Each of the plurality of the filtering plates 14 is connected at its upper portion to a filtrate reservoir 36 disposed to be outside of the sludge tank 12 via a distribution tube 34. One end of a filtrate discharge tube 38 is connected to the filtrate reservoir 36 and a filtrate discharge valve 40 is provided on an intermediate part of the filtrate discharge tube 38 extending downwardly.

Each of the distribution tubes 34 and the filtrate discharge tube 38 are connected in a U-shaped manner via the filtrate reservoir 36, so that the filtrate which has been filtered within the sludge tank 12 is discharged outside based on siphon-age. In addition, a suction tube 31 is branched from each of the distribution tubes 34 and a vacuum pump 35 is connected to the suction tube 31 via a suction valve 33 provided on an intermediate part thereof. This causes the liquid within the sludge tank 12 to be treated to be sucked to the distribution tubes 34 by operating the vacuum pumps 35 while the suction valves are open, whereby a preparation for discharging the filtrate outside via the filtrate discharge tube 38 based on the siphon-age can be carried out.

On the other hand, one end of an air supply tube 42 is connected to the filtrate reservoir 36 and a compressor 46 is connected to the air supply tube 42 via an air supply valve 44 provided on an intermediated part thereof. This causes compressed air to be supplied to a filtering chamber 76 of each of the filtering plates 14 via the air supply tube 42, the filtrate reservoir 36 and the corresponding distribution tube 34 by operating the compressor 46 while the air supply valve 44 is open, whereby the corresponding filtering cloth 18 can be expanded in a case where the condensed sludge which is described below is separated from said filtering cloth 18.

In this connection, one end of each of the distribution tubes 34 is connected to a horizontal tube 15 provided on the upper portion of the corresponding filtering plate 14, and an outlet opening (not shown) is provided on the lower portion of the horizontal tube 15 at every zone of the corresponding filtering cloth 18 which is divided by seams 74 adjacent to each other which is described below. This causes the compressed air to be fed to every zone of the filtering cloth 18 by the compressor 46 via the corresponding outlet opening or causes a siphoning type suction to be effected by the vacuum pump 35.

Since the structures of the plurality of the filtering plates 14 are the same, the structure of one of the filtering plates will be described below.

As show in FIG. 3, the filtering plate 14 generally comprises a filtering frame 48, a supporting plate 50 disposed to be inside of the filtering frame 48, the filtering cloth 18 in a bag form inside of which the supporting plate 50 is housed, a plurality of coil springs 54 provided between the filtering frame 48 and the supporting plate 50. The filtering frame 48 is shaped to be hollow and rectangular and includes an upper side 56, a lower side 58 and lateral sides 60, 62 between the upper side 56 and the lower side 58. The filtering plate 14 is suspended and supported from an inner side surface 68 of the sludge tank 12 by both end portions of the upper side 56. More specifically, as shown in FIG. 4, an extension 64 is provided on each of both end portions of the upper side 56, while a pair of guide plates 70, 72, each of which protrudes towards inside, are provided on the inner side surface 68 of the sludge tank 12, so that an engaging plate 66 fixed on the upper surface of the extension 64 is adapted to rest on the upper surface of the pair of the guide plates 70, 72 by disposing the end portion of the extension 64 to be between the pair of guide plates 70, 72. This causes each of the filtering plates 14 to be suspended from the sludge tank 12. The distance between the adjacent filtering plates 14 is determined by selecting the pair of guide plates 70, 72 from which the filtering plates 14 are suspended. Such a distance may be varied by selecting the pair of guide plates 70, 72 in accordance with the amount of condensed sludge deposited on the filtering cloth 18, the value of the negative pressure caused by the suction, and the lateral length of the zone of the filtering cloth 18 which is described below, for instance.

The supporting plate 50 is in the form of a net or mesh and is rectangular-shaped. Innumerable fine holes are provided on the supporting plate 50. A plurality of flow paths of the filtrate, each of which extends in the vertical direction of the supporting plate 50 are formed between the concave portion of the supporting plate 50 and the inner surface of the corresponding filtering cloth 18 by the fact that concave and convex portions (not shown) vertically extending are provided on the surface of the supporting plate 50. The supporting plate 50 is made of resin, and in particular, it is preferable that the supporting plate 50 has characteristics such that it neither extends in a plane of the supporting plate 50, nor is deformed to deteriorate a flatness of the supporting plate 50 due to the fact that the filtering cloth 18 is immersed into the sludge, and furthermore, it neither contracts in a plane of the supporting plate 50 nor is deformed to deteriorate the flatness of the supporting plate 50 due to the fact that the filtering cloth 18 is expanded.

More specifically, the supporting plate 50 is preferably made of polyethylene or EVA. In a case where the filtering cloth 18 is immersed into the sludge for a long time, or the filtering cloth is expanded, a tension force applied to the filtering plate 14 by the coil spring 54 which is described below can be maintained to be substantially constant by adopting such material.

The filtering cloth 18 is preferably made of chemical fiber, more preferably, nylon. The filtering cloth 18 may be formed into a bag form by overlapping a pair of rectangular cloth to sew the overlapped peripheral edge portions, or bending a single rectangular cloth so as to overlap the opposed edge portions to sew the peripheral edge portions. A plurality of eyelets 78 are provided on the periphery of the filtering cloth 18 so that one end of the coil spring 54 which is described below can be hooked by the corresponding eyelet 78.

A plurality of seams 74, each of which vertically extends, are provided on the filtering cloth 18, and the filtering cloth 18 is integrally sewed on the supporting plate 50 which is housed in the filtering cloth 18. This causes the filtering cloth 18 to be divided along the lateral direction (the direction perpendicular to the vertical direction of the sludge tank 12), thereby causing the filtering chamber 76 to be formed between the inner surface of the filtering cloth 18 and the supporting plate 50 at each divided zone (refer to FIG. 5). The distances between the adjacent seams 74 do not have to be the same, however, it is preferable that such a distance be determined in view of the fact that the total filtering area of the whole filtering plates 14 is maximized by disposing the filtering plates 14 to be as close as possible, while causing no risk of contact of the adjacent filtering plates 14.

More specifically, as shown in FIG. 5(A), in order to separate the condensed sludge from the filtering cloth 18, by feeding a compressed air into the corresponding filtering chamber 76 by the compressor 46, in a case where the filtering cloth 18 is expanded, the filtering cloth 18 is caused to protrude toward the adjacent filtering plate. However, such a protrusion P can be decreased by dividing the filtering cloth 18 in the lateral direction and expanding each divided zone, whereby the distance D can be shortened.

In addition, the lateral length of the filtering cloth 18 is set to be longer than that of the corresponding supporting plate 50 at every zone which is divided by the adjacent seams 74 of the filtering cloth 18 over the entire vertical length of the filtering cloth 18. This causes an expanding margin to be provided at every zone in a case where the filtering cloth 18 is expanded. As shown in FIG. 5 (B), in case of filtering, most of the filtering cloth 18 is adhered to the surface of the corresponding supporting plate 50 by the fact that the filtering cloth 18 is sucked by the filtering chamber 76, a wrinkled portion 71 which is not adhered to the supporting plate 50 is formed along the vertical direction of the supporting plate 50.

A space which extends in the vertical direction of the filtering cloth 18 is formed between the inner surface of the non-adhering portion 71 of the filtering cloth 18 and the surface of the corresponding supporting plate 50 at every divided zone. The space is communicated with the corresponding filtering chamber 76 defined by the inner surface of the filtering cloth 18 and the corresponding supporting plate 50. Accordingly, the filtrate which has passed through the filtering cloth 18 can vertically flow through the space, so that the space can function as a sub-flow passage 99 for the main flow passage for the filtrate formed on the corresponding supporting plate 50. This causes the sub-flow passage 99 to be formed at every divided zone, thereby the permeability of the filtrate to be improved.

On the other hand, in a case where the filtering cloth 18 is expanded, the filtering cloth 18 can be prevented from being unduly tensioned to lose a normal filtering performance, or it can be prevented from being broken or torn due to the fact that the fine holes of the filtering cloth 18 is forced to be enlarged.

A plurality of coil springs 54 are provided between the lateral side 60 of the filtering frame 48 and the lateral side 61 of the corresponding filtering cloth 18, the lateral side 62 of the filtering frame 48 and the lateral side 63 of the corresponding filtering cloth 18, and the lower side 58 of the filtering frame 48 and the lower side 59 of the corresponding filtering cloth 18. A distance between the adjacent coil springs 54 provided on both lateral sides 60, 62 and the lower side 58 of the filtering frame 48 may be determined in accordance with the size of the filtering cloth 18, the amount of the condensed sludge deposited on the filtering cloth 18, etc. More specifically, one end of each of the coil springs 54 is hooked by the eyelet 78 of the corresponding filtering cloth 18, while the other end thereof is fixed to the lateral sides 60, 62 or the lower side 58 of the corresponding filtering frame 48.

On the other hand, a plurality of connecting members 65 are provided between the upper side 56 of the filtering frame 48 and the upper side 57 of the corresponding cloth 18, and one end of each of the connecting members 65 is hooked by the eyelet 78 of the corresponding filtering cloth 18, while the other end thereof is fixed to the upper side 56 of the corresponding filtering frame 48. The connecting members 65 may preferably be suspending metal fittings such as shackles, for instance. According to the above structure, a tension force is always applied to the entire periphery of the filtering plate 14 including the upper, the lower, and the both lateral sides. This tension force causes the filtering plate 14 to be stable, so that, in a case where the filtering operation is conducted in a suction manner, for instance, the condensed sludge deposited on the filtering cloth 18 due to the filtering operation in a suction manner can be prevented from being spontaneously separated from the filtering cloth 18, or the filtering plate 14 can be prevented from contacting the adjacent filtering plate 14 to lose the effective filtering area, due to the fact that the filtering plate 14 can flutter or shake. The plurality of the coil springs 54 may preferably be made of SUS, from the corrosion resistant point of view, and may preferably be standard products, not made-to-order products, since tens of the coil springs are disposed to be around the periphery of the filtering plate 14, and tens of filtering plates 14 are used.

Now, the operation of the filtering and condensing apparatus of the suction type 10 including the above structure will be described.

Firstly, the sludge is fed to the sludge tank 12. More specifically, the sludge supply/discharge valve 26 is opened while the sludge discharge valve 32 is closed, and then the sludge supply/discharge pump 28 is actuated, so that the sludge which is to be filtered and condensed is fed into the sludge tank 12 up to a level which corresponds to a top portion of the filtering plate 14 via the sludge supply/discharge tube 24.

Then, the preparation for filtering and condensing the sludge in the sludge tank 12 in a siphoned manner is carried out. More specifically, the suction valve 33 is opened and the vacuum pump 35 is actuated, so that the liquid in the filtering clothes 18 is sucked into the filtrate reservoir 36 via the distribution tubes 34. The filtrate guided into the filtering chambers 76 can be discharged outside via the sludge discharge tube 38 by the siphon-age in accordance with the difference between the level of the end portion at the side of the filtering plate 14 of each of the distribution tubes 34 and the level of the filtrate reservoir 36.

Then, the sludge in the sludge tank 12 is filtered and condensed. More specifically, the sludge in the sludge tank 12 is sucked toward the outer surface of each of the filtering clothes 18 by the siphon-age. At this stage, water contained in the sludge passes through the filtering clothes 18 and is guided into the filtering chambers 76 as filtrate, while the sludge is dehydrated, so that the condensed sludge is deposited on the outer surfaces of the filtering clothes 18. Since the margin for expanding the filtering cloth is provided at every zone of each of the filtering clothes 18, most of the filtering cloth 18 in every zone is caused to be adhered to the corresponding supporting plate 50 due to the fact that the filtering cloth 18 is sucked, while the portion 71 which is not adhered to the supporting plate 50 is formed into a wrinkle extending in the vertical direction of the filtering cloth 18.

As shown in FIG. 3, non-adhering portions 71 extend in the longitudinal direction of the corresponding filtering plate 14 in a meandering manner.

A space which extends in the vertical direction of the filtering cloth 18 is formed between the inner surface of the non-adhering portion 71 of the filtering cloth 18 and the surface of the corresponding supporting plate 50 at every divided zone. The space is communicated with the corresponding filtering chamber 76 defined by the inner surface of the filtering cloth 18 and the corresponding supporting plate 50. Accordingly, the filtrate which has passed through the filtering cloth 18 can vertically flow through the space, so that the space can function as a sub-flow passage 99 for the main flow passage for the filtrate formed on the corresponding supporting plate 50 to improve the permeability of the filtrate.

Since the wrinkled non-adhering portion 71 is newly formed at every divided zone every time the filtering operation is conducted, it tends to have a small badly influence on an integrity of the filtering cloth, however, a kind of tendency can be generated due to the use of the filtering cloth for a long time. This causes the non-adhering portion 71 to be formed on the same position of the filtering cloth 18 every time the filtering operation is conducted. In such a case, a bad influence on the filtering cloth 18 due to the generation of the non-adhering portion 71 can be prevented by regulating the negative pressure generated within the filtering chamber 76, for instance. In a case where the filtering cloth is made of nylon, for instance, the value of the negative pressure may be preferably higher than −0.09 Mpa, however, this value may be determined in accordance with the material, the size, and the thickness of the filtering cloth, and the amount of the sludge deposited on the surface of the filtering cloth.

Since a tension force is constantly applied to each of the filtering plates 14 from its periphery, each of the filtering plates 14 is maintained to be stable. This causes the condensed sludge deposited on the outer surfaces of the filtering clothes 18 to be prevented from being separated from the outer surfaces of the filtering clothes 18 due to the fluttering or the shaking of the filtering plates 14.

Then, non-condensed sludge in the sludge tank 12 is discharged outside from the sludge tank 12. More specifically, the sludge supply/discharge valve 26 is opened and the sludge supply/discharge pump 28 is reversely actuated with respect to the case where the sludge is fed, so that the non-condensed sludge in the sludge tank 12 can be discharged outside via the sludge supply/discharge tube 24.

Then, the condensed sludge deposited on the filtering clothes 18 can be separated from the filtering clothes 18 by expanding the filtering clothes 18. More specifically, the air supply valve 44 is opened and the compressed air is fed into the filtering chamber 76 of each of the filtering plates 14 from the compressor 46 through the air supply tube 42, the filtrate reservoir 36, the corresponding distribution tube 34 and the corresponding horizontal tube 15. This causes each of the filtering clothes 18 whose innumerable fine holes are closed by the condensed sludge to be expanded in the direction in which each of the filtering clothes 18 is away from the corresponding supporting plate 50.

At this stage, the entire inner surface of the filtering cloth 18 is caused to be detached from the surface of the supporting plate 50, while the wrinkled non-adhering portion 71 is caused to disappear, due to the fact that the entire surface of the filtering cloth 18 is tensioned so as to be away from the corresponding supporting plate 50. This also causes the sub-flow passage 99 inside the filtering cloth 18 to disappear, however, in a case where the expansion of the filtering cloth 18 is halted and the filtering operation is conducted again, as described above, the wrinkled non-adhering portion 71 is formed again, so that the sub-flow passage 99 is newly formed.

In addition, since the expanding margin is provided on every divided zone of the filtering cloth 18, the filtering cloth 18 can be prevented from being excessively tensioned in such a way that the fine holes are forced to be enlarged, or that the filtering cloth 18 is caused to be broken. Further, the supporting plate 50 integrally sewed on the corresponding filtering cloth 18 is subjected to the compressive force due to the expansion of the filtering cloth 18, so that it is forced to be laterally contracted (the lateral direction in FIG. 5). However, the lateral length of the supporting plate 50 can be maintained to be substantially constant due to the rigid supporting plate 50, whereby the tension force by the coil springs 54 transmitted from the side of the supporting plate 50 can be maintained to be substantially constant.

Then, the separated condensed sludge is discharged outside from the sludge tank 12. More specifically, the sludge discharge valve 32 is opened, and then the condensed sludge deposited on the bottom of the sludge tank 12 is discharged outside of the sludge tank 12 via the condensed sludge discharge tube 30 due to the gravity force. The above processes complete the filtering and condensing operation of the sludge.

The filtering cloth 18 tends to swell due to the fact that it is immersed into the sludge for a long time, whereby the corresponding supporting plate 50 is forced to be laterally extended, too (the lateral direction in FIG. 5). In such a case, the lateral length of the supporting plate 50 can be maintained to be substantially constant due to the rigid supporting plate 50, whereby the tension force by the coil springs 54 transmitted from the side of the supporting plate 50 can be maintained to be substantially constant.

The condensed sludge which is discharged outside from the sludge tank 12 is further condensed by another hydrator to be formed into a cake, and then, incinerated or reclaimed.

According to the above filtering and condensing apparatus 10 of the suction type, by sucking and thus filtering the sludge contained in the sludge tank 12 through the filtering clothes 18, water contained in the sludge passes through the filtering clothes 18 and is guided into the filtering chambers 76 and then flows through the main flow passages formed on the supporting plates 50 to be discharged outside via the filtrate discharge tubes, and as a result, the sludge is filtered and thus condensed by the dehydrated sludge being deposited on the outer surfaces of the filtering clothes 18.

In this case, since the lateral length of the filtering cloth 18 is set to be longer than the lateral length of the corresponding supporting plate 50 over its entire vertical direction, the filtering cloth 18 is pressed against the surface of the corresponding supporting plate 50 due to the hydraulic pressure by the sludge and the predetermined negative pressure applied to the filtering cloth 18 via the corresponding filtering chamber 76, and thus, most of the filtering cloth 18 is adhered to the surface of the corresponding supporting plate 50, while the wrinkled portion 71 which does not adhere thereto is also formed. A vertically extending space is formed between the inner surface of the wrinkled portion 71 and the surface of the corresponding supporting plate, and said space is communicated with the corresponding filtering chamber 76 defined by the inner surface of the filtering cloth 18 and the corresponding supporting plate 50. Accordingly, the filtrate which has passed through the filtering cloth 18 can vertically flows through the space, and thus, the space can function as a sub-flow passage 99 with respect to the main flow passage of the filtrate formed on the corresponding supporting plate 50, whereby permeability of the filtrate can be improved.

In a case where the filtering cloth 18 is expanded by the filtering cloth expanding means in order to separate the condensed sludge deposited on the surface of the filtering cloth 18, the entire inner surface of the filtering cloth 18 is caused to be detached from the surface of the corresponding supporting plate 50, while at the same time the wrinkled portion 71 which does not adhere to the surface of the corresponding supporting plate 50 is caused to disappear. This causes the inner sub-flow passage 99 to disappear, however, in a case where the expansion of the filtering cloth 18 is halted and the filtering operation is carried out again, the wrinkled portion 71 is formed again, whereby the inner sub-flow passage 99 of the filtrate is formed again.

In this case, since the filtering cloth 18 can be damaged due to the fact that the wrinkled portion 71 is formed repeatedly, it is necessary to set the negative pressure caused by the sucking means to be a predetermined value so as to provide a filtering function for a long time without badly influencing on the filtering cloth 18. The predetermined value may be determined in accordance with the material, the size, and the thickness of the filtering cloth 18, or the amount of the sludge deposited on the surface of the filtering cloth 18.

As described above, the sub-flow passage 99 of the filtrate is temporary in that it is newly formed every time the filtering operation is carried out and it disappears every time the filtering cloth 18 is expanded. Accordingly, since it has a self-purification characteristics, there is no risk of the clogging by the foreign objects which can be caused by the main flow passage formed on the supporting plate 50, and thus, it can function as a sub-flow passage 99 for the main flow passage. Therefore, the filtering efficiency can be maintained because the operation of the filtering and condensing apparatus 10 of the suction type need not be halted in order to remove the clogging which occurs in the main flow passage, while at the same time the filtering performance can be secured by maintaining the permeability of the filtrate.

Now, the second embodiment of the present invention will be described. In the following description, the explanation of elements the same as those in the first embodiment is omitted by attaching the same reference numbers to said elements, and the technical feature of this embodiment will be described in detail. FIG. 6 is an illustration in the filtering and condensing apparatus of the suction type in the second embodiment the same as FIG. 3 in the first embodiment.

As shown in FIG. 6(A), the technical feature of this embodiment lies in the fact that, in each of the filtering plate 14, a weight member 80 is provided on its lower portion. More specifically, the weight member 80 with a predetermined weight including a laterally elongated prism shape, is suspended from the lower portion of each of the filtering plates 14 via a plurality of suspending metal fittings 82. As shown in FIG. 6(B), each of the suspending metal fittings 82 includes a U-shaped body 86 including a pair of extensions 84 parallel to each other and a connecting rod 88 which connects tip ends of the pair of the extensions 84. The weight member 80 is suspended from the corresponding body 86 via a coil spring 90. The plurality of suspending metal fittings 82 are disposed in such a way that the corresponding filtering frame 48 is interposed between the pair of the extensions 84, and connected to the corresponding filtering cloth 18 by introducing the connecting rod 88 into the eyelet 78 of the corresponding filtering cloth 18.

If the coil springs are provided on the lower portion of the filtering plate 14, like the first embodiment, in case of the filtering, the coil springs can be unduly contracted due to the weight of the condensed sludge which gradually deposits on the surface of the filtering cloth 18. However, according to the above structure, since the filtering cloth 18 can be constantly drawn downwardly due to the weight member 80, the filtering cloth 18 can be prevented from being slackened due to the deposition of the condensed sludge on the filtering cloth 18. Further, since the filtering frame 48 is disposed to be interposed between the pair of extensions 84, the corresponding filtering plate 14 can be prevented from excessively being swung toward the adjacent filtering plate 14 due to the fact that said filtering plate 14 contacts the pair of the extensions 84.

As stated above, the preferred embodiments of the present invention were described in detail, however, it is evident that those skilled in the art could modify or change the embodiments in various manners without departing from the scope of the present invention.

For instance, in the first embodiment, the sludge was described to be the object to be filtered and condensed, however, the filtering and condensing apparatus of the suction type of the present invention can be applicable to incineration ash contained in an alkali solution, foreign objects contained in the beverages such as milk, juice, foreign objects in a high turbidity solution, etc., so long as the conditions such as the kind of the filtering cloth, the size of diameter of the fine holes, the suction force, etc. are appropriately set in accordance with the object to be filtered and condensed.

In addition, in the first embodiment, the filtering and condensing apparatus of the siphon type was described, however, the filtering and condensing apparatus of the suction type utilizing a suction pump can be adopted, so long as the negative pressure is appropriately set, taking an influence on the filtering cloth 18 into consideration.

Still further, in the first embodiment, the coil springs 54 were adopted as elastic members, however, rubber plates, etc. can be adopted, so long as the desired tension force can be obtained.

### INDUSTRIAL APPLICABILITY

The filtering and condensing apparatus of the suction type of the present invention can be applicable not only to the technical field of the water treatment, but also to that of the food or chemical industry, and, in particular, it is advantageous in a case where the filtering and condensing apparatus of the suction type, which is to be applied to a condensing process of sludge generated during the water treatment at a water purification plant or a sewage disposal plant, is made large.

### BRIEF DESCRIPTION OF THE DRAWINGS

FIG. 1 is a general view showing a filtering and condensing apparatus of a suction type in the first embodiment of the present invention.

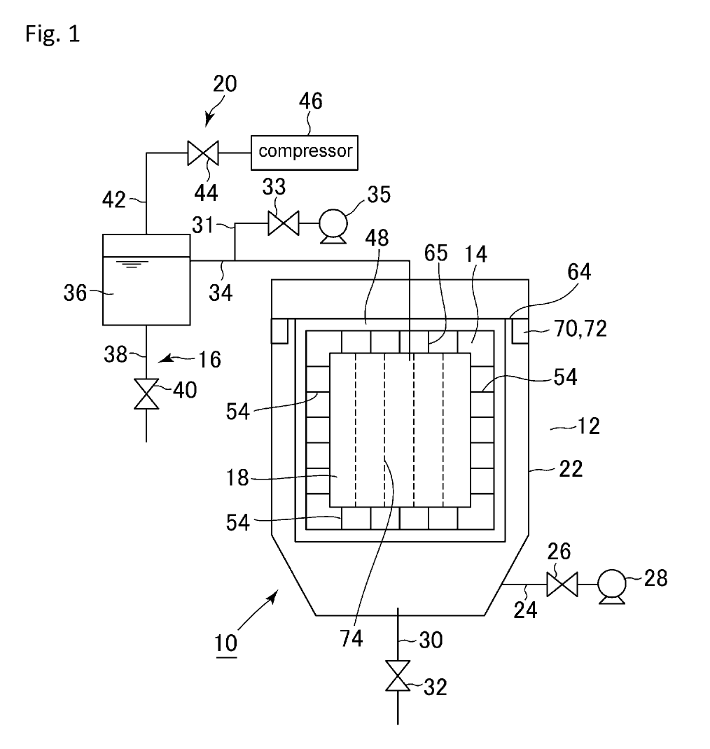

FIG. 2 is a general partial perspective view showing a situation in which a plurality of filtering plates are disposed to be adjacent from each other, in the filtering and condensing apparatus of the suction type in the first embodiment of the present invention.

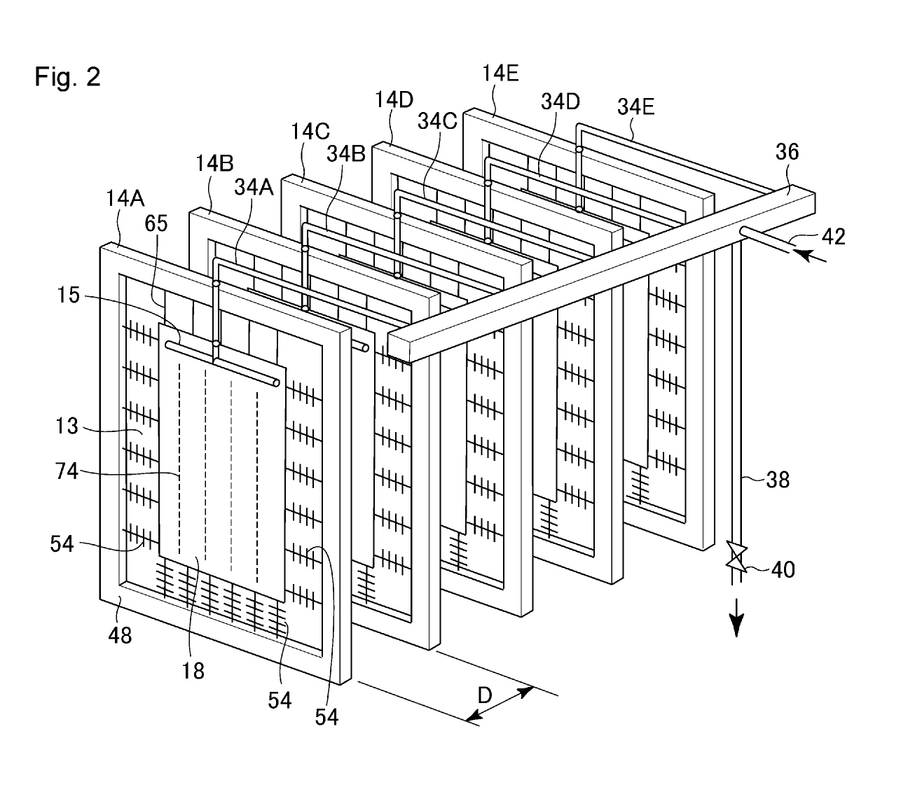

FIG. 3 is a general side view showing a filtering plate in the filtering and condensing apparatus of the suction type in the first embodiment of the present invention.

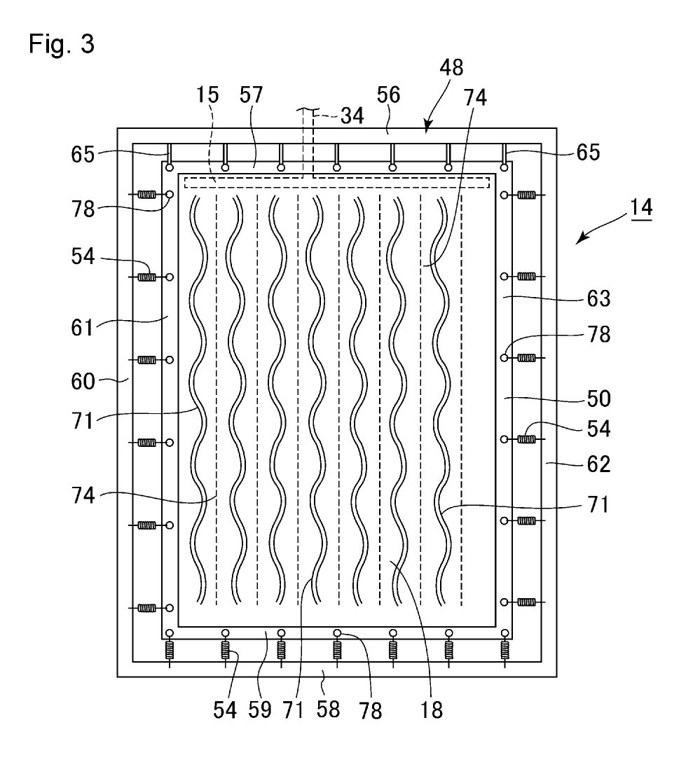

FIG. 4 is a partial plane view showing a situation in which a plurality of filtering plates are suspended and supported from the sludge tank, in the filtering and condensing apparatus of the suction type in the first embodiment of the present invention.

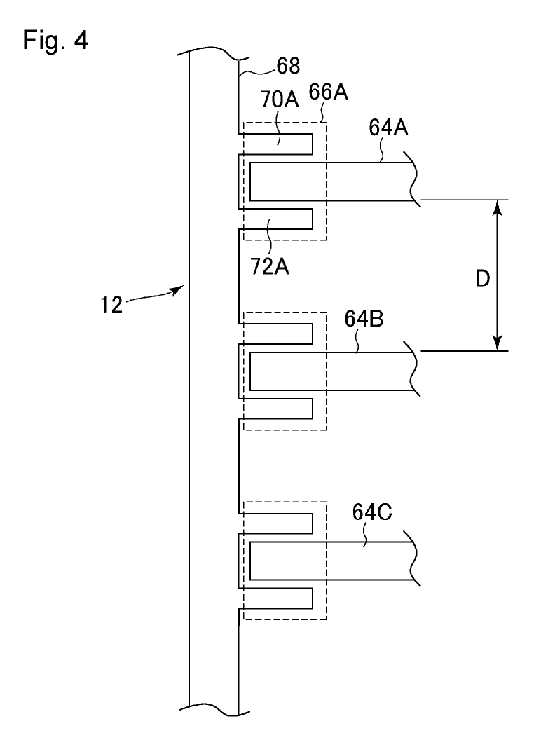

FIG. 5 (A) is a conceptual view showing a situation in which the filtering cloths of the adjacent filtering plates are expanded, and FIG. 5 (B) is a conceptual view showing a situation in which the filtering is carried out by the filtering cloths of the adjacent filtering plates, in the filtering and condensing apparatus of the suction type in the first embodiment of the present invention.

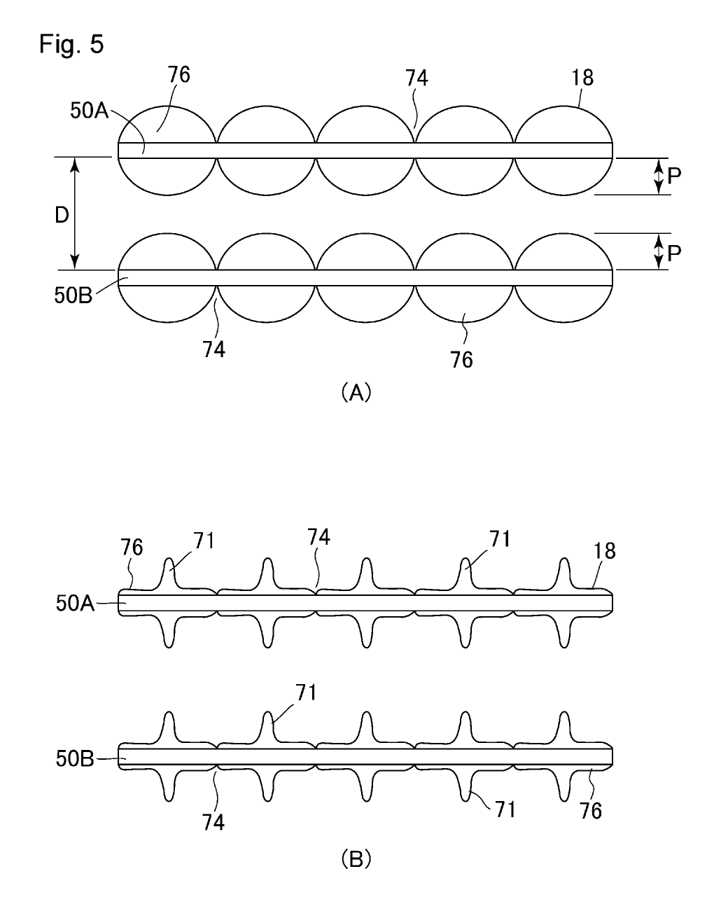

FIG. 6 is a view the same as FIG. 3 in the filtering and condensing apparatus of the suction type in the second embodiment of the present invention.

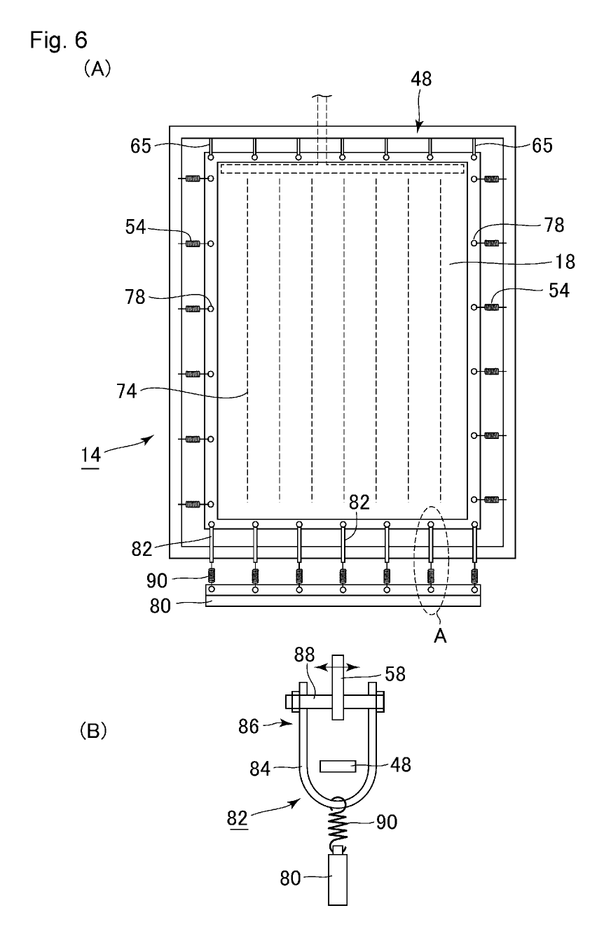

FIG. 7 is a general cross section view showing the supporting plate of the conventional filtering and condensing apparatus of the suction type.

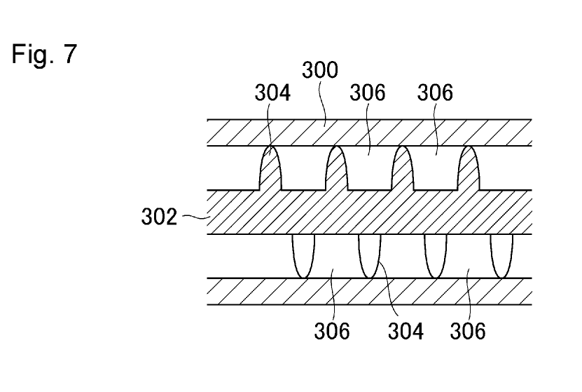

### EXPLANATION OF REFERENCE NUMBERS

P: amount of protrusion
D: distance
10: filtering and condensing apparatus of suction type
12: sludge tank
14: filtering plate
15: horizontal tube
16: suction portion
18: filtering cloth
20: expanding portion
22: side wall
24: sludge supply/discharge tube
26: sludge supply/discharge valve
30: condensed sludge discharge tube
32: condensed sludge discharge valve
34: distribution tube
35: vacuum pump
36: filtrate storage tank
42: air supply tube
44: air supply valve
46: compressor
50: supporting plate
54: coil spring
56: upper side
58: lower side
60, 62: lateral side
71: non-adhering portion
74: seam
76: filtering chamber
78: eyelet
80: weight member
82: suspending fitting
84: extension
86: body
88: connecting rod
90: spring
99: sub-flow passage

What is claimed is:

1. A filtering and condensing apparatus of a suction type comprises a sludge tank for containing sludge to be filtered and condensed, and a filtering plate disposed to be in the sludge tank and extending in the vertical direction of the sludge tank, said filtering plate includes vertical extending convex and concave portions on its surface, and a filtering cloth in a bag form to house said supporting plate, whereby a filtering chamber is formed between the filtering cloth and said filtering plate and a main flow passage for the filtrate which vertically extends is formed between the inner surface of the filtering cloth and the concave portion of said supporting plate, said apparatus further includes a means for sucking said filtering cloth through said filtering chamber, a means for expanding said filtering cloth through said filtering chamber by feeding an air toward the filtering cloth via the filtering chamber, and a filtrate discharge tube one end of which is communicated with said filtering chamber, characterized in that the lateral length of the filtering cloth is set to be longer than the lateral length of the supporting plate over its entire vertical direction, whereby, in a case where the sludge in said sludge tank is filtered and condensed under the predetermined negative pressure by said sucking means, a temporary sub-flow passage for the filtrate which is communicated with said filtering chamber and extends in the vertical direction of the filtering chamber is formed.

2. The filtering and condensing apparatus of a suction type according to claim 1, said filtering cloth is integrally sewed on said supporting plate, and is divided in the lateral direction of the supporting plate by a plurality of vertically extending seams to form said filtering chamber at every divided zone, the lateral length of the divided zone of the filtering cloth divided by the adjacent seams is set to be longer than the lateral length of the supporting plate corresponding to said divided zone over its entire vertical direction, whereby said temporary sub-flow passage is formed at every divided zone.

3. The filtering and condensing apparatus of a suction type according to claim 1, a negative pressure caused by said sucking means is set to be higher than the predetermined value in such a way that a wrinkled portion of the filtering cloth formed upon filtering does not deteriorate an integrity of the filtering cloth.

4. The filtering and condensing apparatus of a suction type according to claim 3, said predetermined value is higher than −0.09 Mpa in a case where the filtering cloth is made of nylon.

5. The filtering and condensing apparatus of a suction type according to claim 3, said filtrate discharge tube is a downwardly extending tube of a siphon type disposed to be in the form of a reverse U-shape.

6. The filtering and condensing apparatus of a suction type according to any of claims 1 to 5, said filtering plate includes a plurality of filtering plates aligned with each other in said sludge tank, each plane portion of which vertically extends.

7. The filtering and condensing apparatus of a suction type according to claim 2, the lateral length of the divided zone of the filtering cloth is determined in accordance with the amount of the protrusion of the filtering cloth toward the adjacent filtering plate upon the expansion of the filtering cloth and the distance between the adjacent filtering plates.

8. The filtering and condensing apparatus of a suction type according to claim 6, a means for always applying a tension force to each of the filtering plates are provided around its periphery, the means for applying a tension force from both sides of each of the filtering plates consists of an elastic member extending in its lateral direction, said supporting plate is made of a rigid material which causes substantially neither extension in its plane due to the immersion of the filtering cloth into the sludge, substantially nor contraction in its plane due to the expansion of the filtering cloth, and causes substantially no deformation so as to deteriorate a flatness of the supporting plate due to the immersion and the expansion of the filtering cloth.

9. The filtering and condensing apparatus of a suction type according to claim 8, said supporting plate is made of polyethylene.

10. The filtering and condensing apparatus of a suction type according to claim 8, said supporting plate is made of EVA.

11. A filtering and condensing apparatus of a suction type comprises a filtering and condensing tank for containing a liquid to be filtered and condensed, and a filtering plate disposed to be in the filtering and condensing tank and extending in the vertical direction of the filtering and condensing tank, said filtering plate includes vertical extending concave and convex portions on its surface, and a filtering cloth in a bag form to house said supporting plate, whereby a filtering chamber is formed between the filtering cloth and said filtering plate and a main flow passage for the filtrate which vertically extends is formed between the inner surface of the filtering cloth and the concave portion of said supporting plate, said apparatus further includes a means for sucking said filtering cloth through said filtering chamber, a means for expanding said filtering cloth through said filtering chamber by feeding an air toward the filtering cloth via the filtering chamber, and a filtrate discharge tube one end of which is communicated with said filtering chamber, characterized in that the lateral length of the filtering cloth is set to be longer than the lateral length of the supporting plate over its entire vertical direction, whereby, in a case where the sludge in said sludge tank is filtered and condensed under the predetermined negative pressure by said sucking means, a temporary sub-flow passage for the filtrate which is communicated with said filtering chamber and extends in the vertical direction of the filtering chamber is formed.
